(19) United States
(12) Patent Application Publication
(10) Pub. No.: US 2017/0140355 A1
(43) Pub. Date: May 18, 2017

(54) SYSTEMS AND METHODS FOR TICKET VENDING MACHINES FOR TRANSIT TICKET PURCHASES FOR IMPAIRED PURCHASERS

(71) Applicant: Trapeze Software ULC, Mississauga (CA)

(72) Inventors: Mike HUNTING, Cedar Rapids, IA (US); Robert VERPLAETSE, Cedar Rapids, IA (US)

(21) Appl. No.: 15/351,808

(22) Filed: Nov. 15, 2016

Related U.S. Application Data
(60) Provisional application No. 62/255,707, filed on Nov. 16, 2015.

(51) Int. Cl. G06Q 20/18; G06Q 50/14; G07C 9/00

(52) U.S. Cl. CPC G06Q 20/18; G07C 9/00007; G06Q 50/14

(57) ABSTRACT

The invention is a system for allowing a visually impaired transit rider to purchase a transit service product from a computer automated ticket vending machine terminal. The system uses an interface designed to assist a visually impaired rider by guiding the rider to various components on the terminal using audible prompts and directions through a headset, so that the rider may select and make a payment for a transit service product such as a ticket or pass. The system also relates to a method for the same.

### TECHNICAL FIELD

The invention relates generally to purchasing transit tickets from an automated vending machine. More specifically it relates to a Ticket Vending Machine (TVM) system to assist an impaired rider in making a transit ticket purchase.

### BACKGROUND

Self-serve ticket terminals are common place and are relatively user friendly, such that the average person is usually able to purchase a ticket without great difficulty even when the configuration of the machine is unfamiliar. Consumers commonly make a wide variety of commercial transactions using cash or credit/debit options, for example at bank machines, parking lots, gas stations, grocery stores, movie theatres, and transit terminals. Most self-serve ticket terminals are designed for people with no visual impairments and include some sort of display screen.

Despite the user-friendly interface, it is difficult for those with disabilities—particularly impaired vision—to use an automated ticket vending machine terminal. While some adjustments have been made, such adjustments are not adequate and are not generally offered to purchasers of transit tickets.

As such, improvements to address such problems are desirable.

### SUMMARY OF THE INVENTION

In one embodiment there is a system for allowing an impaired transit rider to purchase a transit service product from a ticket vending machine, comprising: a ticket vending machine operable in a regular mode and an assisted mode further comprising a ticket vending machine computer, a user interface comprising a touchscreen, a headset jack, a payment acceptor, and a processor on the ticket vending machine computer executing computer readable instructions to: activate an assisted mode of operation upon receipt of an assisted mode trigger; facilitate navigation to, and selection of, a transit vehicle service via one or more non-visual instructions provided to the impaired rider; guide the rider to provide payment for the transit vehicle service; and distribute the transit service product to the impaired rider.

In an aspect of the embodiment the navigation is facilitated via one or more non-visual instructions.

In an aspect of the embodiment the non-visual instructions comprise at least one geographic-auditory instruction.

In an aspect of the embodiment the geographic-auditory instruction comprises an x axis motion amount and a y axis motion amount.

In an aspect of the embodiment the non-visual instructions comprise at least one tactile-auditory instruction.

In an aspect of the embodiment the at least one tactile-auditory instruction comprises a series of raised markings to the lead the impaired rider's hand to an intended destination, the raised marking's tactile feel being representative of the intended destination.

In an aspect of the embodiment the touchscreen may have an alternate display configuration when the assisted mode is active.

In an aspect of the embodiment the alternate display configuration offers alternate transit service products for purchase than in the regular mode.

In an aspect of the embodiment the assisted mode trigger is insertion of a headset into the headset jack or insertion of an assisted card in the payment acceptor.

In an aspect of the embodiment the system further comprises an assisted card provider configured to provide an assisted mode confirmation to the ticketing machine if the assisted card is authenticated.

In an aspect of the embodiment transit service product price is reduced if the assisted card is authenticated.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 is a diagram of the ticket vending system according to a non-limiting embodiment of the present invention;

FIG. 2 is a diagram of the ticket vending machine terminal according to a non-limiting embodiment of the present invention;

FIGS. 3A-3D represent configurations that may appear on the touchscreen of the ticket vending machine user interface according to a non-limiting embodiment of the present invention; and

FIG. 4 is a flowchart showing the method of purchasing a transit service product using the ticket vending machine system according to a non-limiting embodiment of the present invention.

### DETAILED DESCRIPTION OF THE INVENTION

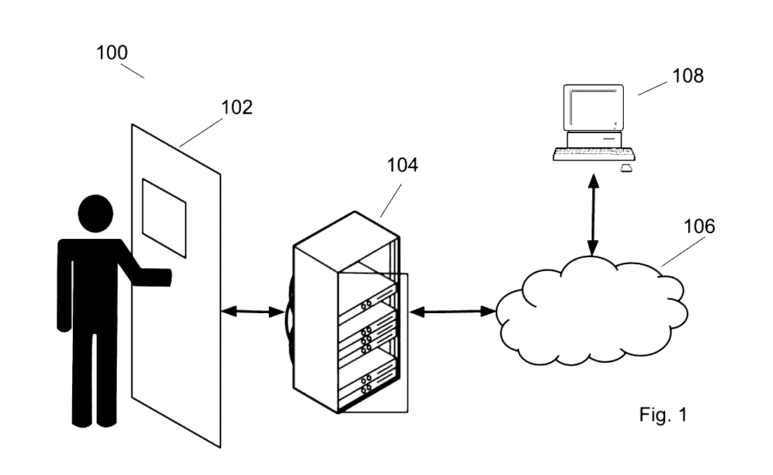

FIG. 1 is a diagram of the ticket vending system 100 comprising: ticket vending machine terminal (TVM) 102, TVM computer 104, communication network 106, and offsite computer 108.

Ticket vending system 100 may be used by transit agencies to allow users of system 100 (such as riders, potential riders, drivers of transit buses, and the like) to facilitate purchasing of transit service products (such as bus tickets or tokens, bus passes, and the like). System 100, or portions thereof, may be installed at a transit agency location, along a transit route, at popular locations within a city, and other locations where a rider may want to purchase a transit service product. Transit service products may have one or more features (such as an agency, a route, a date/time, a seat location or seat type, a vehicle type, and the like). Purchasing a transit service product may then include selecting at least enough of the features to uniquely identify the transit service product to be purchased.

TVM 102 may be the main interface for a user to purchase a transit service product as described herein. TVM 102 may be located at any location where it is desirable to purchase a transit service product such as a ticket to ride on a public transit vehicle.

TVM computer 104 may have a number of physical and logical components, including a central processing unit, random access memory, an input/output interface (such as touchscreen 202, keypad 208 and the like), a network interface, non-volatile storage, and the like (not shown). The various components execute an operating system and computer-executable instructions for implementing vending machine software and controlling TVM 102. The network interface enables communication with external systems through the communication network 106.

Communication network 106 may be substantially any public or private network, wired or wireless, and may be substantially comprised of one or more networks that may be able to facilitate communication between the various elements of system 100.

Offsite computer 108 may be one or more computer systems or servers that may facilitate the transit service product purchase through TVM 102. One or more offsite computers 108 may belong to payment processors such as banks and credit card companies and transit agencies that sell transit service products. Offsite computers 108 may need to be contacted to verify credit and debit purchases of transit products, and verify current prices of available transit service products.

In one embodiment offsite computer may be part of an agency that assists disabled persons, such as the National Institute for the Blind, and the like. Such agencies may, using offsite computer 108 (impairment agency server), maintain records of persons with impairments, such records including personal details and impairment details (what impairments a person may have, the degree to which they have it, and preferences for handling their impairments, for example). Such agencies may provide their members (who may be riders of transit vehicles who are seeking to purchase tickets) identification cards that may store or enable a system to determine details about such rider/member. Of course such functionality (offsite computer and ID cards) may be implemented by each transit agency, individually or as a collective, or by a government or quasi-governmental organization (such as under the Americans With Disabilities Act).

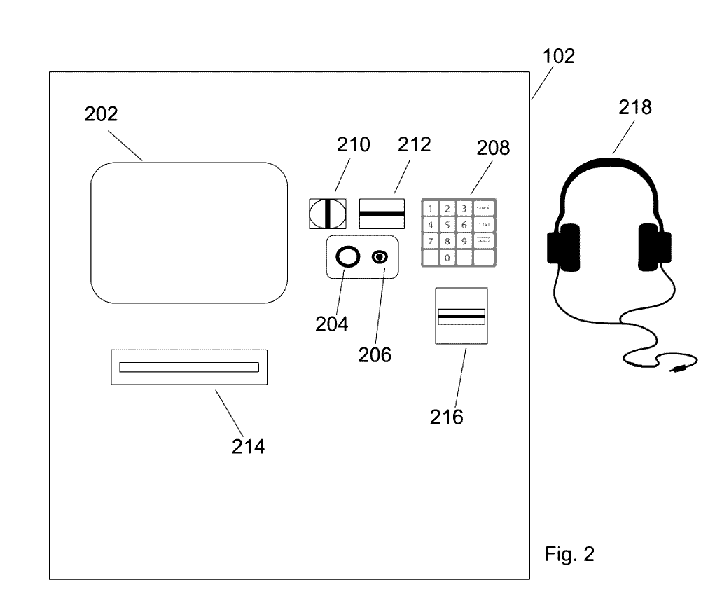

FIG. 2 is a diagram of the ticket vending machine terminal (TVM) 102 comprising touchscreen 202, start/volume button 204, headset jack 206, keypad 208, coin acceptor 210, card acceptor 212, output tray 214, banknote recycler 216, and headset 218. TVM 102 may allow a user to purchase a transit service product in a self-serve fashion. Some of the elements of TVM 102 may be similar to known features common to automated vending machines.

TVM 102 may be wall mounted at sidewalk level, and each element may be configured in a way that may be beneficial for disabled transit riders. The configuration and functionality of the various elements of TVM 102 may meet the general requirements set out by the Architectural and Transportation Barriers Compliance Board in Section 707 of Part 1191 of Title 36 of the Code of Federal Regulations, hereby incorporated by reference. For example, TVM 102 may have at least some of the following dimensions (which are intended as exemplary only, being one embodiment of TVM 102):
Coin acceptor 210 and card acceptor 212 may be 47.24 inches above ground level;
Center position of touchscreen 202 may be 46.68 inches above ground level;
Start/volume button 204 and headphone jack 206 may be 43.41 inches above ground level;
Keypad 208 may be 44.78 inches above ground level;
Banknote recycler 216 may be 38.11 inches above ground level; and
Output tray 214 may be 16 inches directly below the center position of touchscreen 202, or 30.68 inches above ground level.

TVM 102 may have at least two modes or operation: one regular sales mode and one mode of operation to assist riders with disabilities, such as visual impairments (“Assisted Mode”). Assisted Mode may be triggered automatically such as when a user plugs headset 218 into headset jack 206 or inserts an impairment identification card in card acceptor 212. If the user removes headset 218 from headset jack 206 at any time during the transaction, the transaction may be cancelled and the system may revert to the regular sales mode.

Assisted Mode may allow the purchase of only one product per transaction, for example to ensure that assisted cards are used properly or to ensure customers requiring such mode are not taken advantage of Assisted Mode may also support a reduced fare option. The reduced fare option may be available only during pre-defined hours configured for each system. The reduced fare option may be available only to certain individuals, and those individuals may use a special ID card, such as an impaired rider identification card, to initiate the reduced fare option. The reduced fare option may give riders the ability to purchase transit service products for a discount, or special products not available to the public. Further, functioning of TVM 102 in assisted mode may require more energy (such as playing audio, creating vibrations, and the like, such that assisted mode should only be in effect when required/triggered (and may have a timeout feature such that assisted mode ends if no actions are taken within a particular amount of time). In one embodiment when TVM 102 enters Assisted Mode one of the products available for purchase (such as Product 3 306) may be displayed, whereas Product 3 306 may not otherwise be generally available for purchase. Of course, being shown on touchscreen 202 may not fully enable a user/rider to purchase such product; insertion of an “assistance”/“impairment” identification card (which may be provided by an agency itself even) may still be required during processing of the purchase of Product 3.

Touchscreen 202 may be a touch sensitive display area that allows a user to interact with TVM 102, for example to access functionality that is part of TVM computer 104 and described herein. This may be via displaying visual cues such as text, graphics and images in various colors, and optionally making some of such visual cues and user interface elements as being selectable, such as via touch (either a pressing motion, a releasing motion, a press and release motion, multiple fingers, and the like). Touchscreen 202 may be capable of receiving user inputs via physical touches, and each physical touch may result in further actions being executed. TVM computer 104 may be capable of tracking the location of a user's finger position on touchscreen 202. Touchscreen 202 may also be capable of providing a tactile response to a user such as a vibration, pulse, or other motion that may be felt physically. In one embodiment, touchscreen 202 may be able to vibrate or create a vibratory effect, in one or more screen portions, such that the rider is led to a screen portion (for example having a selectable button thereon) directly.

Headset jack 206 may be a commonly known input port used to connect headset 218 to TVM 102, for example a 3.5 mm headphone jack input. TVM 102, and TVM computer 104 in particular, may be able to detect when a headset 218 is inserted or removed from the headset jack 206. Headset jack 206 may enable a rider to hear instructions about purchasing a transit service product by sending audio to headset 218.

Headset 218 may be any standard, common set of earphone or earbuds used to listen to audio that may end in a 3.5 mm headphone jack input. Headset 218 may allow a user to hear audible tones, sounds, and speech. Speech may be recorded or digitized human, or synthesized. Audible tones may be used for visible output that is not displayed for privacy/security purposes, such as when entering a personal identification number (PIN). Speech may include operating instructions, transaction prompts, user input verification, error messages, and any other relevant information.

Start/volume button 204 may a button that a user may press to start or reset a transaction. Start/volume button may also adjust the volume of the system audio output to headset 218 during a transaction (such as to cycle through three volume settings). Any transaction may be cancelled at any point in the process by pressing and holding the start/volume button 204. When cancelled, the system may return to the beginning of the transaction while remaining in Assisted Mode. The start/volume button 204 may be labeled using raised letter, such as “Trapeze Font” and may use an industry standard raised headset symbol to mark the location.

Keypad 208 may be a grid of buttons comprising a number pad and various function keys. Keypad 208 may allow a user to complete a transaction using a debit or credit card, or agency identification card, that require a PIN to be entered (for example to allow a particular product, only to be purchased by impaired riders, to be purchased). The number pad may be an arrangement of single digit numbers 0 through 9, “*” and “#” keys, arranged in 12 key ascending or descending order in a standard telephone keypad layout. The number “5” key may be tactilely distinct from the other keys so that a user is able to distinguish number positions. Function keys may have tactile surfaces and may include but are not limited to:
an “Enter” or “Proceed” key, with a raised circle “O”;
a “Clear” or “Correct” key, with a raised left arrow “←”;
a “Cancel” key, with a raised letter “X”;
an Add Value key, with a raised plus “+” sign; and
a Decrease Value key, with a raised minus “−” sign.

Coin acceptor 210 may be a narrow opening in which a user may enter coins as part of the payment process. TVM 102, via TVM computer 104, may keep track of the total amount of money has been deposited and may inform the user of the balance entered and outstanding balance.

Card acceptor 212 may accept various cards, including a debit or credit card to be used for the payment process, for example using a swipe, chip, or tap payment method as is commonly known. Card acceptor 212 may also accept an identification card used to initiate the reduced fare option purchases.

Output tray 214 may be a slat or a narrow covered opening where a user may receive a transit service product such as a ticket or pass and receipt. Output tray 214 may have a lock/unlock status, and may unlock after a successful purchase for a preconfigured amount of time. TVM 102, and TVM computer 104 in particular, may be capable of detecting when a transit service product has been removed from output tray 214. TVM 102 may prompt a user, visually and/or audibly, that a transit service product is waiting in output tray 214.

Banknote recycler 216 may have a thin slot capable of accepting and distributing paper currency used in the payment process. TVM 102 may also contain a secure coin box or box containing paper currency (not shown).

TVM 102 may further comprise a camera (not shown) that may guide a user through a ticket purchase. The camera may be similar to the Xbox™ Kinect™ camera. Such a camera may be able to locate and track a user's hands and then provide instructions for how to move those hands to the appropriate part of TVM 102. The camera may provide its input to TVM computer 104, which may then direct audio signals to be generated and provided to the user.

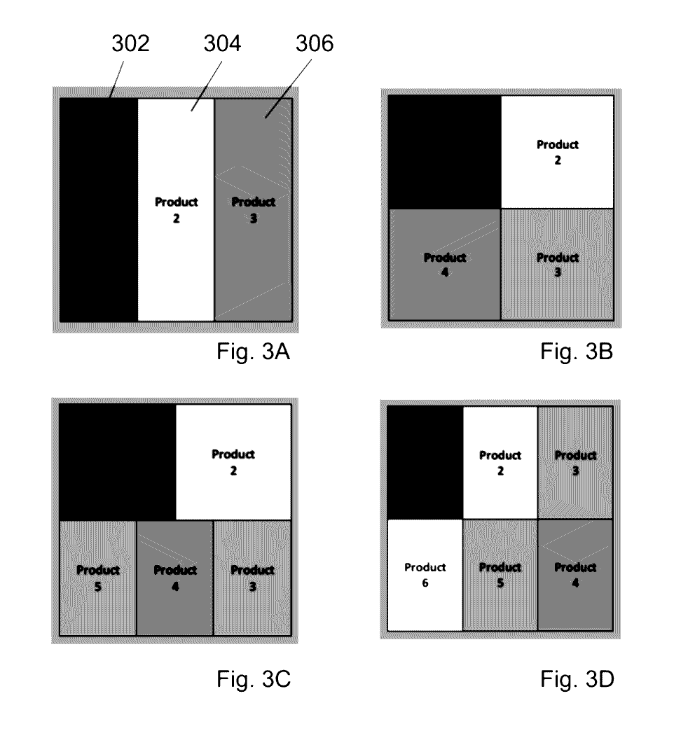

FIGS. 3A-D represent configurations that may appear on touchscreen 202 in Assisted Mode. FIG. 3A shows touchscreen 202 divided into 3 areas 302, 304, and 306. Each area may have a brightly colored background that contrasts to each adjacent area, for example area 302 may be red, area 304 may be amber/yellow, and area 306 may be green. Text may appear in each area that may also highly contrast the area's background color.

After reduced fare option ID card has been inserted into card acceptor 212, touchscreen 202 may have a configuration different from the non-reduced fare option and may show a unique set of products to purchase. Unique products may include products that include an aid worker or aid animal, included as part of the purchased ticket.

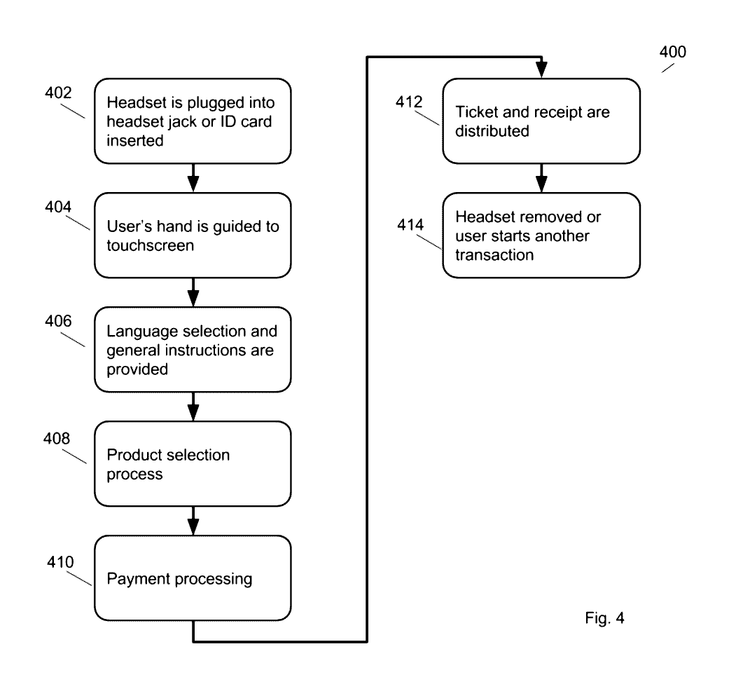

FIG. 4 is a flowchart showing the method of purchasing a transit service product using the ticket vending machine system 100.

Method 400 begins at 402 when TVM 102 detects headset 218 has been plugged into headset jack 206 or an ID card has been entered. TVM 102 may then activate the Assisted Mode. Assisted Mode may result in one or more differences in the process of purchasing a transit product, such as inserting an ID card before beginning the rest of the purchase or causing touchscreen 202 to display an alternate configuration (different from the regular sales mode) such as one of the configurations shown in FIGS. 3A-D that may implement a different purchase workflow or present different products/pricing for purchases. By way of example, upon activating Assisted Mode a rider may be directed to card acceptor 212 and then be presented the touchscreen configuration as shown in FIG. 3C as opposed to that shown in FIG. 3A being directly shown.

At 404 the system may guide the user's hand to touchscreen 202. This may be accomplished, for example, by various non-visual instructions, such as:
1) Audible-Geographic Instructions: instructions that provide an audible cue that describes the geographic layout of TVM 102 and/or how to move a rider's hand to its intended location (either from an original point of reference that may be known by TVM 102, such as via the camera, or essentially from “at the rider's side” and not known to TVM 102). For example, an audible-geographic instruction may be to instruct the user to trace the headset 218 cord down to the headset jack 206, and then to the touchscreen 202 using describing the distances between them, for example saying “Move your hand 6 inches to the left and 4 inches down to arrive at the top right edge of the touchscreen. The touchscreen will be vibrating should that help you locate it. Touch the volume bottom, just to the right of your headset's attachment to the ticketing machine, if you are lost or need to re-start.”. Alternatively if the camera is used, the instruction may be, “You are moving your hand in the right direction, keep moving in that direction for another foot. We will let you know once your hand has arrived.”;
2) Tactile Instructions (with or without accompanying Audible Instructions”):

Instructions that direct a rider's hand to its intended location, with optional accompanying audio (again either from an original point of reference that may be known by TVM 102 or essentially from “at the rider's side” and not known to TVM 102). For example tracing the headset cord 218 to the headset jack 206 and then a series of tactile such as raised markings, or responsive sections, or vibrations on the TVM 102;

An audio message, delivered through headset 218, may then prompt the user to tap touchscreen 202 or volume button for at least one alternate language, for example Spanish, or to wait for English. (“Toque la pantalla para el Español”) Verbal instructions may then be provided in the selected language through headset 218.

At 406, the system may provide the user general operating instructions through headset 218. The user may also be instructed about how to change the volume level and how to cancel a transaction using the start/volume button 106. The system may also instruct the user about the reduced fare option and how to insert a reduced fare ID card into the card acceptor 212. The instructions may inform the user of the location of various elements of TVM 102, for example, speech that says “The card acceptor slot is 6 inches up and to the right of the headset jack”. Of course it is to be understood that various numbers of instructions, content of the instructions, types of instructions and the like can be used to guide a rider through the purchasing process for a particular transit service product.

At 408, after receiving instructions (following approaches such as are described herein) about the product selection process, the user may select a product. This may involve:
1) Highlighting a first feature of the transit service product to be purchased by pressing, holding, and moving a finger over different areas of touchscreen 102. A first feature may be “train” versus “bus” or a route number, for example. TVM computer 104 is able track the location of the user's finger on touchscreen 102. The user may choose different product features by moving a finger over different areas of touchscreen 102, for example while the user's finger is in area 302, “Product 1” may be highlighted, as the user's fingers moves to area 304 “Product 2” may become highlighted. TVM 102 may announce to the user, via headset 218, the currently highlighted product or feature, and the user may be given a description of the currently highlighted product or feature. The announcement of highlighted product or feature may be repeated at a preset interval. If the user moves a finger out of bounds of the product selection area, the user may hear a warning message, for example “Out of bounds”. Of course there may be a border (not shown) around a product area on touchscreen 202 that may, when a rider's finger enters the border, issue such a warning or cause a message to change.
2) Selecting a first feature of a transit service product by removing the finger from touchscreen 102 while the desired product feature is currently highlighted. TVM 102 may prompt the user for either a confirmation, for example by requiring a further press on touchscreen 102, or a cancellation, for example by pressing start/volume button 204 which may restart the product selection process. The exact nature of selecting a feature or product, versus a rider tracking their finger to find what they are seeking, may vary. In one embodiment a single finger may be on touchscreen 202 for tracking, then a further touch in the same area, within a certain time of the finger being removed, may indicate selection. In another embodiment a second “selection finger” may be added to the “tracking finger” before the tracking finger is removed. Other embodiments are considered within the scope of the present invention.
3) Specifying further features of the transit service product to be purchased. As a way of example, touchscreen 102 may be configured as FIG. 3A and a first set of product features may be a list of bus routes. After a first feature has been confirmed, touchscreen 102 may show configuration FIG. 3B, which may display a list of departure and arrival times. This process may continue until a complete transit service product can be confirmed, at which point TVM 102 may proceed to payment processing.

At 410, the touchscreen 202 may show the payment processing display where the user can choose how to pay, for example by cash or credit/debit card. The payment processing display may be similar to FIG. 3A, but may have only two areas 302 and 304, each area taking up approximately half the display screen. Each area 302 and 304 may have a brightly colored contrasting background. For example area 302 may display “Cash” with a bright green background and area 304 may display “Credit/Debit” with a bright red background. The text displayed in each area may brightly contrast with the area's background color.

Similar to the product selection process, the user may place a finger on the touchscreen 202. TVM 104 may track the location of the user's finger position on touchscreen 202 and may send an audio message to the user, via the headset 218, informing the user of the currently highlighted payment method. The user may select the desired payment method by removing a finger from the touchscreen 202 (or another “tracking/selecting” approach as described herein).

If the user selects cash, TVM 102 may prompt the user to enter an appropriate cash payment and may then guide the user to the coin acceptor 210 and/or banknote recycler 216. TVM 102 may instruct the user, through headset 218, that coin acceptor 210 and/or banknote recycler 216 are located at a certain position on TVM 102, for example a message stating “Please move your hand six inches up and two inches right of the start button to find the coin acceptor slot”. In another embodiment, TVM 102 may instruct the user to trace a finger along a strip or series of raised markings or feel for other tactile responsive elements. For example, a series of “P” markings (in braille) may lead from an edge of touchscreen 202 to a payment acceptor, while a series of “H” markings (or headset logos, etc) may lead from an edge of touchscreen 202 to headset jack.

TVM 102 may instruct the user to enter coins in the coin acceptor 210 before entering any bills in the banknote recycler 216. TVM 102 may inform the user through headset 218 how much cash has been entered and how much is still owing after each insertion of coin or paper currency. The amount entered and remaining balance may also be displayed on touchscreen 202. TVM 102 may instruct the user to the location of banknote recycler 216 through audio instructions, for example “six inches up and 5 inches right of the start button”, or by tracing tactile markings on TVM 102.

If the user selects credit/debit, there may be a further selection required for credit or debit, and TVM 102 may prompt the user to insert a card into card acceptor 212 using audio/visual cues. TVM 102 may instruct the user to the location of the card acceptor 212 and keypad 208, if necessary, through audio instructions about the locations on the TVM 102 or by instructing the user to trace and follow markings. Audio and/or visual cues may alert the user to the status of the transaction approval or disapproval or any card insertion issues.

If a credit/debit option is not available at a particular TVM 102, the user may be notified through an announcement and the user may be informed they may continue with a cash payment or cancel the transaction by pressing the start/volume button 204.

TVM computer 104 may process the payment by determining if the full amount of cash has been inserted, or by communicating with external payment processors to obtain a verification of the credit or debit card. If TVM computer 104 determines the full cash amount has been inserted or verifies the credit or debit card, TVM computer may process the completed payment, for example by charging the credit card, and may notify the user, through headset 218, that the payment was successful. If the credit or debit card is not processed successfully, the user may be informed of such and may be given a choice to select an alternate payment method.

At step 412, upon a successful completion of payment, TVM 102 may inform the user that the purchase is complete and distribute the purchased transit service product to the user by sending the product to the output tray 214 and unlocking the output tray 214. TVM 102 may then instruct the user to take the transit service product from output tray 214 using audio/visual cues. A separate receipt may also be distributed with the transit service product. Output tray 214 may unlock for a preset time, or until the transit service product is removed. TVM 102, via TVM computer 104, may alert the rider if a transit service product has not been removed from output tray 214, for example after a preset time has elapsed. The alert may be a combination of an audible signal through headset 218, a visual cue on touchscreen 202, or a tactile response.

At 414, the user may be prompted to either remove headset 218 if finished or make another transaction. If the user removes headset 218, TVM 102 may exit Assisted Mode.

It will be apparent to one of skill in the art that other configurations, hardware etc may be used in any of the foregoing embodiments of the products, methods, and systems of this invention. It will be understood that the specification is illustrative of the present invention and that other embodiments within the spirit and scope of the invention will suggest themselves to those skilled in the art. All references cited herein are incorporated by reference.

1. A system for allowing an impaired transit rider to purchase a transit service product from a ticket vending machine, comprising:
a ticket vending machine operable in a regular mode and an assisted mode,
a user interface,
a processor on the ticket vending machine executing computer executing computer readable instructions to:
activate the assisted mode of operation upon receipt of an assisted mode trigger;
facilitate navigation to, and selection of, a transit vehicle service via one or more non-visual instructions provided to the impaired rider;
guide the rider to provide payment for the transit vehicle service; and distribute the transit service product to the impaired rider.

2. The system according to claim 1, wherein the navigation is facilitated via one or more non-visual instructions.

3. The system according to claim 2, wherein the non-visual instructions comprise at least one geographic-auditory instruction.

4. The system according to claim 3, wherein the geographic-auditory instruction comprises an x axis motion amount and a y axis motion amount.

5. The system according to claim 2, wherein the non-visual instructions comprise at least one tactile-auditory instruction.

6. The system according to claim 5, wherein the at least one tactile-auditory instruction comprises a series of raised markings to the lead the impaired rider's hand to an intended destination, the raised marking's tactile feel being representative of the intended destination.

7. The system according to claim 1, wherein the user interface includes a touchscreen having an alternate display configuration when the assisted mode is active.

8. The system according to claim 7, wherein the alternate display configuration offers alternate transit service products for purchase than in the regular mode.

9. The system according to claim 1, wherein the assisted mode trigger is insertion of a headset into a headset jack

10. The system according to claim 1, wherein the assisted mode trigger is insertion of an assisted card in a payment acceptor.

11. The system according to claim 10, further comprising an assisted card provider configured to provide an assisted mode confirmation to the ticketing machine if the assisted card is authenticated.
